(19) United States
(12) Patent Application Publication
(10) Pub. No.: US 2015/0191366 A1
(43) Pub. Date: Jul. 9, 2015

(54) ELECTRO-CATALYTIC PROCESS FOR COALESCING AND SKIMMING POLLUTANTS IN BODIES OF WATER PRIOR TO FILTRATION

(71) Applicant: OriginOil, Inc., Los Angeles, CA (US)

(72) Inventor: Nicholas Eckelberry, Los Angeles, CA (US)

(73) Assignee: OriginOil, Inc., Los Angeles, CA (US)

(21) Appl. No.: 14/632,846

(22) Filed: Feb. 26, 2015

Related U.S. Application Data
(63) Continuation-in-part of application No. 14/109,336, filed on Dec. 17, 2013.
Application No. 14/109,336 is a continuation-in-part of application No. 13/865,097, filed on Apr. 17, 2013.
(60) Provisional application No. 61/945,687, filed on Feb. 27, 2014.
(60) Provisional application No. 61/625,463, filed on Apr. 17, 2012.

(51) Int. Cl. C02F 1/24

(52) U.S. Cl. CPC C02F 1/24; C02F 2103/10

(57) ABSTRACT

Polluted water is emulsified at micron level in order to increase contact zones within the matrix through micro-bubble mass transfer attributes. The medium is then subjected to electro-magnetic pulses generated by catalytic multiple metal oxidizing anodes rods horizontally and centrally positioned in a cathode coated material tube generating a DC electric field in the matrix thereby coalescing particulates through catalytic reaction mechanisms. The ionized and coalesced product is then flowed to a flotation container comprised of a plurality of hydrogen and oxygen bubbles generated through a secondary set of electro- catalytic metal anodes and cathode rods at the bottom of the vessel now intermingled with cavitating micro-bubbles force the pollutants out of solution to the surface for ease of recovery. This method of handling fluids eases the pollutant load on the final filtration of water, thereby optimizing flow through filtration media or membranes for compliance to water discharge laws.

### CROSS-REFERENCE TO RELATED APPLICATIONS

This application claims priority to U.S. Provisional Patent Application No. 61/945,687, filed Feb. 27, 2014, and entitled “An Electro-Catalytic Process for Coalescing and Skimming Pollutants in Bodies of Water Prior to Filtration.” This application is related to and represents a continuation-in-part of U.S. patent application Ser. No. 13/865,097, filed Apr. 17, 2013 and entitled “Harvesting and Dewatering Algae Using a Two-Stage Process,” and claims priority to U.S. Provisional Patent Application No. 61/625,463, filed Apr. 17, 2012 and entitled “Solute Extraction from an Aqueous Medium Using a Modular Device,” This application is additionally related to and represents a continuation-in-part of U.S. patent application Ser. No. 14/109,336, filed Dec. 17, 2013 and entitled “Removing Compounds from Water Using a Series of Reactor Tubes Containing Cathodes Comprised of a Mixed Metal Oxide.”

### BACKGROUND OF THE INVENTION

1. Field of the Invention

The present invention relates to water purification, and more particularly to a process for coalescing and skimming pollutants in water prior to filtration.

2. Background and Related Art

Some embodiments in U.S. patent application Ser. No. 13/865,097 disclose that algae cells can be separated from water using a two stage process comprising: an array of electrified reactor tubes that coalesce the algae within the water; wherein the algae may subsequently be flocculated in a tank and forced to rise to the top of the matrix through the generation of hydrogen and oxygen bubbles produced by a second set of electrified rods positioned at the bottom of the recovery tank.

Some embodiments in U.S. patent application Ser. No. 13/865,097 disclose a method of extracting bio-mass from a solution. Other embodiments disclose a method of solute extraction from an aqueous medium using a modular device. In some embodiments the contact area between the anodes and cathodes, may be altered, either increasing or decreasing the contact area between the anodes and cathodes. For example, the contact area between the anodes and cathodes may be increased by super-imposing another set of cathode rods on top of an anode which was itself suspended on a set of cathodes; thereby creating a dual electrification zone increasing the contact zones between the metals to affect an increase in the generation of H2 and O2 in the flocculation zone. In some embodiments this effected separation of hydrocarbons from spent water.

In some embodiments a combination of coalescing and flocculation has been found to be effective at solute extraction in an aqueous medium for organic compounds suspended within the matrix.

In additional embodiments the systems and methods may be utilized in diverse applications. For example, some of the potential applications are discussed in Ser. No. 14/109,336. For example the systems and methods may be utilized for removing compounds from water using a series of reactor tubes containing cathodes comprised of a mixed metal oxide. In other embodiments, the production of Hypochlorite through the device may be performed as a breakpoint chlorination device, effectively neutralizing ammonia compounds and pathogens with a pass through said reactor tubes (SSE).

In some embodiments anodes and/or cathodes may comprise various metal blends. For example titanium may be coated with metals from the platinum group (ruthenium, rhodium, palladium, osmium, iridium, and platinum), in varying blends such as ruthenium, palladium or iridium, rhodium and platinum and electrified. Various elements of the system and method may be controlled by utilizing differing metal blends. For example, an increase in the production of hydrogen or an increase in chlorine gas production. As an additional example a ruthenium weighted blend may be used in the chlorine gas manufacturing industry to extract chlorine from sea-water and iridium weighted blends increase H2 production. In some embodiments, systems and methods comprise the generation of chlorine, in combination of electro-magnetic forces and vortexial contact zones, may be used to create an ionization process with organic material at the same moment in time as the HCl generation, thus bringing into immediate and timely contact the solute and the chlorine in solution to affect coalescence of the solute within that matrix or in the case of ammonia, for example, the breaking of the NH bonds or the molecular destruction of prokaryote outer cell wall, but not the nuclei of single celled organisms, thus effectively destroying bacterium while preserving eukaryotes.

In some embodiments a process maybe the combination of electricity and platinum group metals multiple metal oxides (MMOs) within a body of water to catalyze the fluid rather than electro-chemically alter the water since there is no donation of ferrous or aluminum ions understood within the electro-coagulation and electrolytic arts as ion donors. In some embodiments, as catalysts rather than donors, the process has the advantage of not adding metals to the matrix which then later have to be removed to comply with discharge water quality standards and also extend the useful life of cathodes thereby lowering operational costs.

In U.S. Provisional Patent Application No. 61/625,463, it was also disclosed that certain modifications to the utility such as introducing a percentage of the gases produced in the coalescing stage at its final pass stage (last reactor tube) through a bypass valve and back through the input pump at the beginning of the serially connected reactor tubes increased the volume of gases which now return into solution thereby supplementing the generation of new ionized gases such as HCl, H2 and O2 in the array, and generating ever increasing contact zones between polluted matrix and oxidizing gases enabling us to decrease both the amount of power and contact time to affect the coalescence or in the case of ammonia and other organic material: ionic transformation.

In some embodiments, the optimization of this two staged electro-catalytic process has led to lowered operational costs and increased flow through capacity and engendered modification designed to affect specific organic compound such as hydrogen sulfide found in oil well produced water for example. And while transformation of H2S is predominantly featured as the organic compound on which these modifications are based, other organosulfur, covalent bonds and organic compounds suspended in a solution can be similarly affected.

### BRIEF SUMMARY OF THE INVENTION

The present invention relates to water purification, and more particularly to a process for coalescing and skimming pollutants in water prior to filtration. In some embodiments, polluted water is first emulsified at micron level through a static mixer or other conveyance in order to increase contact zones within the matrix through micro-bubble mass transfer attributes. The medium is then subjected to electro-magnetic pulses generated via catalytic multiple metal oxidizing anodes rods horizontally and centrally positioned in a cathode coated material tube generating an electric field in the matrix thereby coalescing particulates through catalytic reaction mechanisms. The emulsified and charged product is then flowed to a flotation container comprised of a plurality of hydrogen and oxygen bubbles generated through a secondary set of electro-catalytic metal anodes and cathode rods at the bottom of the vessel which force the pollutants out of solution to the surface for ease of recovery. The decontaminated water is then sent to filters for final polish and re-use or discharge.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a complete side view of the tubes, tank and recovery module.

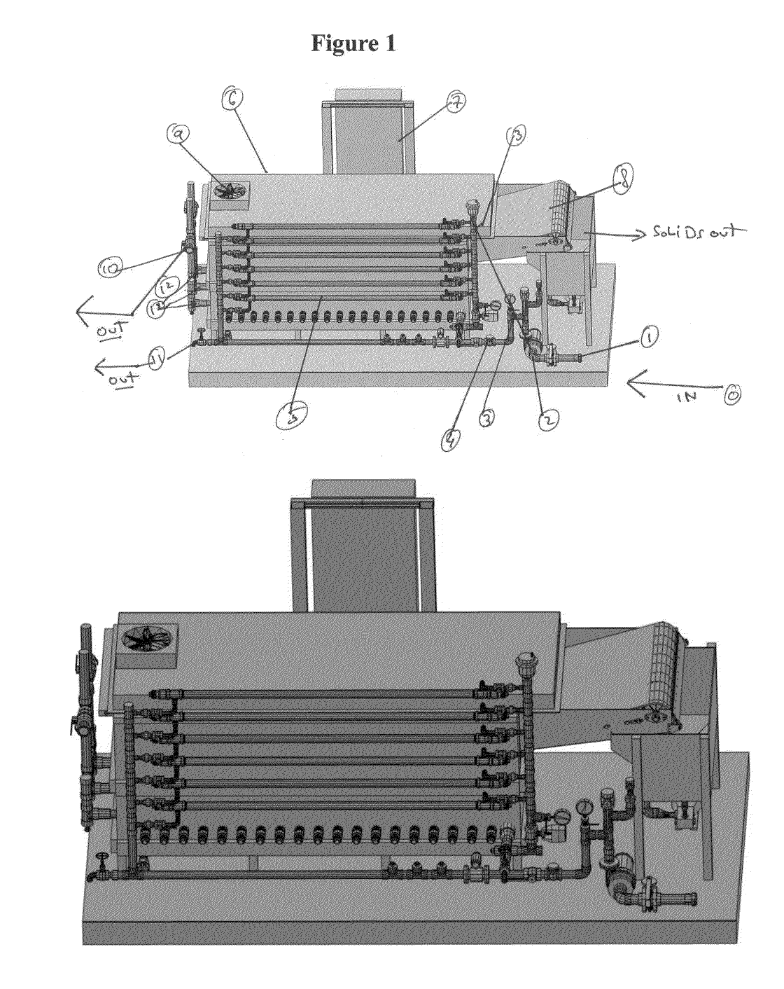

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

For practical purposes, we refer to any material that is non-native to water as a pollutant. Whether these pollutants are organic or inorganic they are differentiated by whether or not they affect chemical oxygen demand (COD) and whether or not they are suspended or dissolved. In this paper we look at organic compounds that are covalently bonded such as NH3, H2S and other organosulfate, esters, and alcohols encysted in water. It should be noted that the COD demand also includes Biological Oxygen Demand (BOD) as these are also lowered through the sterilizing action that is performed in the process. This distinction is important in the differentiation between this system and clarifiers, that do not address these bonds nor pathogens due to their passive non energetic nature and though these compounds can be removed to a certain extent with chemical accelerants prior to clarification this has proven to be a costly and time consuming action. Furthermore, there is a new class of compounds known as pharmaceutical/antibiotic pollutants that are appearing in water streams as increase in human/animal use now taxes waste systems with this new type of pollutant. It is therefore the nature of the use of energy both electric and hydrodynamic cavitation to break these bonds that is at the heart of theoretical nature of this process.

In defining catalysts, we refer to a substance that modifies and increases the rate of reaction without being consumed in the process. For the purpose of this paper, we make use of metals known as MMOs or multiple metal oxides composed of ruthenium, rhodium, palladium, osmium, iridium, and platinum in varying blends. These metals are coated unto a substrate such as titanium for long life and electrical conductivity delivered as a positive charge which itself is understood to be a DC voltage applied in pulses and varying frequencies with adjustable voltage and high amperage. The negative charge or cathode is delivered to a conductive material such as Ti, Stainless Steel or other material which completes the DC circuit within the matrix without metal donation.

In conventional electro-coagulation water treatment, polluted water is flowed through anodes and cathode arrays. In order to perform coalescence or flocculation of the materials suspended in water the art utilizes donating anodes made of materials such as Al or Fe. The ions donated through this process of electrifying the matrix create ionic reactions within the matrix that effectively engender coalescence of the material through ionic bonding of the pollutants to these metal ions. It is contrary to current practices to blend the water and pollutant prior to electro-flocculation; the assumption being that the dispersal of the material throughout the matrix would increase the electrical demand in order to generate more ions to properly flocculate the pollutant out of solution.

We found, however, that micro-mixing and the resulting micro-spheres of product in solution at high pressure; increased in conductivity, lowering transit time of time to separation; provided the blending of the matrix is thorough and to a micron level at a percentage of the total flow of at least 30 to 100%. This level of mixing creates dynamic conditions for increased interfacial area and bubble density which in turn decreases the amount of energy required to permeate and catalyze the medium.

By definition, a micro-bubble is a few hundred micrometers in diameter and has low rising velocity and high inner pressure. This pressure and implosion of its underlying cavity when brought into pressure equilibrium in a larger body of water exude tremendous force and creates a rise of a plurality of microbubbles which pulls solids out of solution forcing this material to the surface of the body of water. This plurality of microbubbles discharged in a low pressure zone, cavitate generating shock waves and force is added to the hydrogen and oxygen generated by the electrified anode/cathodes at the bottom of the flotation tank and forces the rise of compounds hetero in solution to the top of the tank where they are skimmed off.

This method, named “micro-flotation”, has not yet found wide application due to two major reasons: (1) the majority of series flotation plants (utilized primarily for minerals conditioning) usually have bubbles with dimensions over 200 micrometers, which is around one order of magnitude higher than the actual dimensions of aggregates; (2) conventional flotation plants where fine bubbles are generated (electro-flotation and dissolved air flotation) cannot ensure conditions for both efficient aggregation of particles and removal of bubbles loaded with contaminants from water, as the rising velocity of bubbles is very low.

In order to handle the latter of these two problems, as the first is handled by ensuring the static mixer performs properly at ranges below 200 micrometers, the invention suggests that the mixture and the electrification occur prior to the flotation tank so that when it is disgorged, the rise in microbubble velocity is assisted by the electrolysis of the media which produce a plurality of H2 and O2 forcing the microbubbles to the top and in a second instance that the amount of flow micro-mixed is controlled to be a part or the whole of the flow. In this instance, a portion ranging from 10 to 100% of the flow is mixed in this manner and flowed into the main stream. This method appears to ensure a plurality of micro-mixed material transferring properties to the whole while mitigating the potential of over micro-mixing.

Therefore in this primary embodiment, polluted water is entrained through a pump and subjected to a static mixer which partially to fully blends to micron level the slurry to which is added a percentage of the product of the upstream processed fluids which is then flowed under pressure into vortexial and tightly spaced electrified anodic and catalytic tubes which modify and increase the rate of the reaction between fluids. The product is now discharged in a low pressure zone where the process of implosion of hydrodynamic cavitation and further flocculation generated by the underlying anodic generation of H2 and O2 which entrains now separated organic compounds to the top for ease of disposal. It is the increase in pressure, high amperage and increase in interfacial contact which creates the energetic dynamics of the process in handling pollutants in water to force aggregation, coalescence and finally flocculation in the larger body of water. The resultant effluent, now free of excess organic compounds can be filtered or further manipulated without this excess organic load thereby reducing regeneration of media frequency and transit time

In a further embodiment, the use of micro-bubble is used to lower zeta potential¹ in long chain hydrocarbon rich water. And while microbubbles do not seem to affect Zeta potential in distilled water, the addition of inorganic salts such as NaCl reduce the zeta potential and increases electrokinetic potential in colloidal systems, and as water injection in enhanced oil recovery systems (EOR) for the most part utilize saline water, this system is particularly suited for applications within the oil and gas industries where water is injected in formations to increase pressure and recover oil. Further to the use of electrification within the flow is the breaking of NaCl bonds generating Chlorine gas which can be used to deal with Biological fouling is a frequent problem whenever seawater or freshwater is used as cooling or process water for processes such as re-gasification of liquefied natural gas (LNG), or in refineries, petrochemical plants, oil platforms, desalination and power plants. Bio-fouling reduces efficiency and safety of these processes by restricting cooling water flow in pipe runs and reducing heat transfer across heat exchangers and condensers. If it becomes severe enough, the plant will need to be shut down while the problem is remediated. This generated chlorine goes into solution and combines to become a hypochlorite. This process effectively transforms the appliance into an enhanced hypochlorite generator which has value to the oil industry when the produced water is 1 Zeta potential is a scientific term for electrokinetic potential[1] in colloidal systems. From a theoretical viewpoint, the zeta potential is the electric potential in the interfacial double layer (DL) at the location of the slipping plane versus a point in the bulk fluid away from the interface. In other words, zeta potential is the potential difference between the dispersion medium and the stationary layer of fluid attached to the dispersed particle. A value of 25 mV (positive or negative) can be taken as the arbitrary value that separates low-charged surfaces from highly charged surfaces. Colloids with high zeta potential (negative or positive) are electrically stabilized while colloids with low zeta potentials tend to coagulate or flocculate as outlined in the table.

chlorinated and re-injected down-hole. In this embodiment, the recovery tank is not used, but rather the chlorinated water is flowed directly into piping or even down hole to mitigate H2S within the formation itself.

Blending in this manner has the potential to be used in two distinct settings to mitigate H2S both in the water and the “cut”, or potion of the produced water that contains the oil recovered from formation as it is known by the art that chlorination is one of the preferred methods of “sweetening ” oil, ridding it of sulfur. In oil refining, Chlorination is applied at high temperatures to avoid dissociation of the H2S into highly toxic components such as Hydrochloric and sulfuric acid. It is the contention that perhaps substituting pressure, pressure differentials and micro-emulsifying the product could perform a similar task as heat as increasing pressure also increase heat (Gay-Lussac's Law), thereby ridding not only the water but the crude of H2S.

In handling of pollutants, there are ratios that can be formulated depending on the type of product desired. The ratio of micron-mixing can be adjusted so that a portion from 10-100% of the sum total is micro-mixed. The addition of one or two sacrificial anodes can be implanted in lieu of MMO anodes for example when the conductivity of the material requires some ions to be present to perform electro-catalytic processes. Furthermore, current densities require power than can be adjusted as to frequency where more H2 production is required for example 2.4 MHz is considered to be desirable. Other factors such adjustments in pulsing of the DC can be used to lower energy requirements.

The figure represents an embodiment of the invention as built recently to flow 150 liters/minute. The polluted water (0) is entrained through hoses (1) to a pump (2) into which has been induced a percentage of the product of the end of the SSE tubes (3) the matrix, now judiciously injected with gases flows towards a static mixer (4) where the totality of the flow is micron-mixed thereby creating micro-emulsions, micro-bubbles and micron-gases it then flows to a sequence of tubes in which are placed horizontally and contain centrally embedded anodes in a cathode housing (5). The electro-catalytic process, whose direct current is supplied by power supply (7), regulated to parameters matching the values of the matrix, as to conductivity, pH and density. The electrified blend is then disgorged into tank (6) where a set of anodes and cathodes (12) are horizontally placed at the bottom of the tank and electrified in order to produce H2 and O2 bubbles. In the act of pouring out from the high pressure zone within the tubes to this large tank, the micro-/emulsion/bubble mix implodes onto itself as a characteristic of cavitation implosion and this compels the pollutant to the surface where it is collected on a matt (8) for recovery. Not shown is the DAF industry standard rake and belt system. An additional safety feature is the spark proof exhaust system (9) to exhaust any excess gases. The water now free of solids is then flowed through outlets (10). It should be noted that in the case of hypochlorite production, the chlorinated flow (11) is discharged after the SSE s and not disgorged into the floatation tank (6). The duality of the design allows for multiple uses within the same environment. In the case of chlorinated flows, the micron mixture can be directly used in a field for example or in pipes to clean out anaerobic build up with the advantages inherent to micro-bubble implosion phenomenon such as shock and ultrasonic waves which optimize delivery chorine to these sites.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method to remediate polluted water comprising the steps of:
micron-mixing all or part of the matrix within itself, reducing pollutants held in suspension to less than 200 micrometers;
processing the mixture through a series of catalytic material coated tubes which electrify the mixture to force aggregation with pressure and vortexial movement;
disgorging the catalytically altered mixture into a low pressure zone, where the foreign matter is flocculated to the top of the tank for retrieval and disposal;
processing the particulate free water with less regeneration of media, thereby saving time and expense of media replacement.

2. The method of claim 1, wherein the micron-mixture is brought into contact with hypochlorite generated as part of the electro-catalytic process and decontaminated of biological elements within that water.

3. The method of claim 2, wherein residual water can then be injected down a oil bearing formation.

4. The method of claim 3, wherein the residual water is chlorine rich.

5. The method of claim 3, wherein the injected residual water further enhances the quality of crude by dissociating elemental sulfur from hydrogen.
